(19) United States
(12) Patent Application Publication
(10) Pub. No.: US 2007/0088607 A1
(43) Pub. Date: Apr. 19, 2007

(54) MEASURING DWELL TIME ON AN INTERNET ADVERTISEMENT

(75) Inventor: Gary F. Feierbach, Belmont, CA (US)

Correspondence Address: INTELLECTUAL PROPERTY LAW OFFICES, 1901 S. BASCOM AVENUE, SUITE 660, CAMPBELL, CA, 95008, US

(73) Assignee: TAMAGO, Belmont, CA (US)

(21) Appl. No.: 11/538,778

(22) Filed: Oct. 4, 2006

Related U.S. Application Data
(60) Provisional application No. 60/723,510, filed on Oct. 4, 2005.

(51) Int. Cl. G04F 1/00; G04B 47/00; G06F 15/173

(52) U.S. Cl. 705/14; 368/89; 368/10; 709/224

(57) ABSTRACT

A process for measuring the dwell time of a user on an advertiser's clickable advertisement in a sponsor's web page, browser, or downloaded program (a “channel”) appearing in a global communications network like the Internet. A click event by the user is monitored for in the channel. Whether the click event is on the advertisement is then determined. If the click event is on the advertisement, a start time is obtained and a log entry is opened that the user is accessing the advertisement. If the click event is not on the advertisement, whether a log entry already exists is determined and if a the log entry does exist, a stop time is obtained and the dwell time is calculated based on a difference between the start time and the stop time.

### CROSS-REFERENCE TO RELATED APPLICATIONS

This application claims the benefit of U.S. Provisional Application No. 60/723,510, filed 4 Oct. 2005, hereby incorporated by reference in its entirety.

### TECHNICAL FIELD

The present invention relates generally to click on advertising in global communications networks like the Internet, and more particularly to measuring the dwell time that a user spends on an advertisement in such a network. It is anticipated that the measured dwell times will primarily be used for pricing advertising space, although other uses for the present invention are also envisioned, such as analyzing user interest levels to improve the impact of advertising, etc.

### BACKGROUND ART

Click on advertising has been in use for years in global communications networks like the Internet. Typically, click on advertising provides information to web page or browser sponsors such as a user's identity or IP address and the advertiser's identity or internet IP address.

A major problem with conventional click on advertising, however, is that there is no way to satisfactory measure and collect the time that a user spends viewing an advertisement. This information can be quite useful, for example, to determine whether a click was accidental, whether the user has no interest in the offering of the advertisement, or to infer the extent of the user's interest in the offering of the advertisement.

Another problem with conventional click on advertising is that a pop up type advertisement is often clicked on in the wrong place, in an effort by the user to get rid of it, and this click is then also counted and charged to the advertiser.

Both of these technical problems contribute to multiple business problem with conventional click on advertising today. One of these is that determining a “fair” price to charge for online advertising space is difficult, due to a lack of reliable metrics upon which to base it. Similarly, accurately gauging the impact of such advertising, for instance, to increase impact is also currently difficult due to a lack of reliable metrics.

Accordingly, what is needed now is an improved system to measure dwell time by a user on an advertisement appearing in a global communications network like the Internet.

### DISCLOSURE OF INVENTION

Accordingly, it is an object of the present invention to provide a system to measure dwell time by a user on an advertisement appearing in a global communications network like the Internet.

Briefly, one preferred embodiment of the present invention is a process for measuring the dwell time of a user on an advertiser's clickable advertisement in a sponsor's web page, browser, or downloaded program (hereinafter a “channel”) appearing in a global communications network like the Internet. A click event by the user in the channel is monitored for. Whether the click event is on the advertisement is then determined. If the click event is on the advertisement, a start time is obtained and a log entry is opened indicating that the user is accessing the advertisement. If the click event is not on the advertisement, whether a log entry already exists is determined and if so a stop time is obtained and the dwell time is calculated based on a difference between the start time and the stop time.

An advantage of the present invention is that it provides a system to measure dwell time by a user on an advertisement appearing in a global communications network like the Internet.

Another advantage of the invention is that it permits charging a more “fair” price for online advertising.

Another advantage of the invention is that it permits inferring the degree of interest a user has in an online advertisement.

Another advantage of the invention is that it permits transforming a user's dwell time into a charge to an advertiser using an online advertisement.

And another advantage of the invention is that it permits sending individual, grouped or bundled messages that contain identity information for a user and an advertiser, and the dwell time or a transformed dwell time, or a preset maximum dwell time to a sponsor of an online advertisement.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figure of drawings in which:

FIG. 1 is a flow chart depicting a dwell measurement process in accord with the present invention.

### BEST MODE FOR CARRYING OUT THE INVENTION

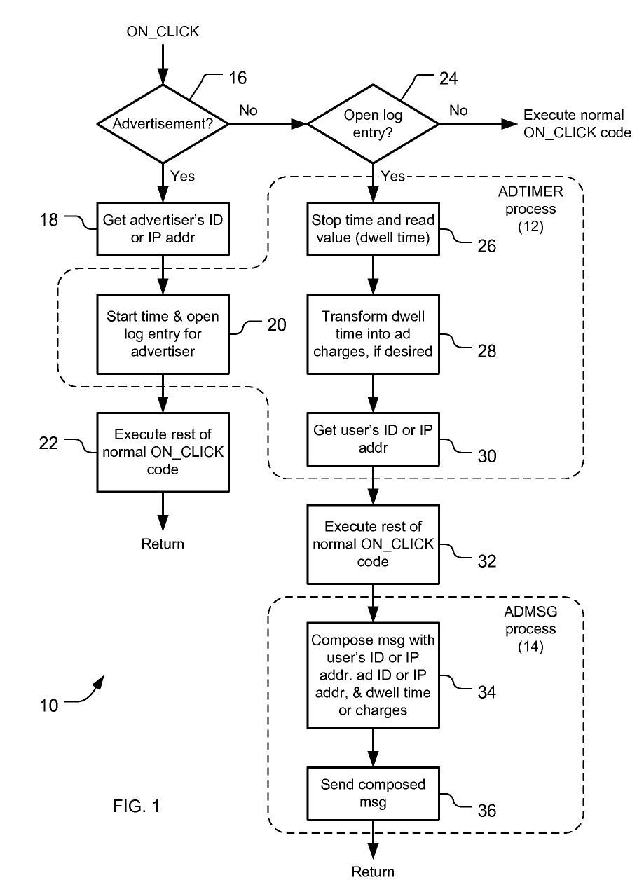

A preferred embodiment of the present invention is a system to measure dwell time by a user on an advertisement appearing in a global communications network like the Internet. As illustrated in the view of FIG. 1, preferred embodiments of the invention are depicted by the general reference character 10.

FIG. 1 is a flow chart depicting a dwell measurement process 10 in accord with the present invention. As shown, the inventive dwell measurement process 10 particularly includes two sub-processes: an ADTIMER process 12 and an ADMSG process 14.

Briefly, to employ the dwell measurement process 10 a sponsor provides a page, browser, or downloaded program (hereinafter the sponsor's “channel”) that contains one or more clickable advertisements. When a user clicks on one of these advertisements conventional ON_CLICK code is encountered.

The ADTIMER process 12 measures the time from when the user clicks on the advertisement to when they return from it. The elapsed time here is the dwell time the user has spent on the advertisement. If the elapsed time exceeds a preset maximum value, the maximum can be used instead. If the user does not return from clicking on the advertisement, the next time the user enters the sponsor's channel a previously logged entry can be noted and the preset maximum can be used for the dwell time.

The dwell time value may then be optionally transformed into a charge to the advertiser. A calculation used for this can be a function based on a table of time intervals mapped to discrete cost steps, a linear function relating cost to dwell time, an exponential function so that longer dwell times can cost disproportionately more, or an asymptotic function so that longer dwell times are not charged a great deal more that moderate dwell times.

After gathering and processing this information, the ADTIMER process 12 passes it to the ADMSG process 14.

Upon receiving the information from the ADTIMER process 12, the ADMSG process 14 composes a message, typically containing: the identity (ID) or internet IP address of the user, the ID or internet IP address of the advertiser, and the dwell time or transformed dwell time that the user spent on the advertisement.

The ADMSG process 14 then sends the message to the sponsor of the channel from which the advertisement is displayed, typically via email, FTP, UDP, or using a common gateway interface (CGI).

Optionally, the ADMSG process 14 can aggregate and save these messages, to send the aggregate at a later time or on a periodic basis. The aggregate then may be one message that contains the information from multiple different advertisement clicks.

The steps in the flow chart in FIG. 1 show this in more detail. Prior to a step 16, the sponsor has provided the channel which contains one or more clickable advertisements and the user has clicked on one of these and activated the ON_CLICK code.

In step 16 the dwell measurement process 10 determines whether this click event was on an advertisement. Here it was, so a step 18 follows where the advertiser's ID and/or IP address are obtained. [Effectively, an advertiser's IP address is itself a form of identification.]

Next is a step 20, which is part of the ADTIMER process 12. Here a start time is obtained (e.g., a timer can be started or a time location can be read) and the advertiser ID or internet IP address is logged.

And next, in a step 22, the normal ON_CLICK code is executed and the dwell measurement process 10 is exited.

Subsequently, the user again clicks in the sponsor's channel, only now not on one of the clickable advertisements, and the ON_CLICK code is again activated. [Of course, in a more sophisticated scenario the user could click on a different clickable advertisement. The dwell measurement process 10 here is extendable, in straightforward manner once the contents of this disclosure are appreciated, to deal with this situation as well.]

In step 16 now again the dwell measurement process 10 determines whether this click event was on an advertisement. Here it was not, so a step 24 follows where it is determined whether there is an open log entry. If not, we have no further interest in this click event, the normal ON_CLICK code is executed and the dwell measurement process 10 is exited.

Alternately, however, if there is an open log entry, a step 26 which is part of the ADTIMER process 12 follows. Here a stop time is obtained (e.g., by stopping the timer or again reading the time location) and the elapsed time interval is computed. This becomes the advertisement dwell time. Optionally, the dwell time can be capped at a maximum if it exceeds a preset period.

Optionally, in a step 28, which is also part of the ADTIMER process 12, this dwell time can be transformed into a transformed dwell time (i.e., a charge to the advertiser). Optionally, the transformed dwell time can be capped at a maximum if it exceeds a preset amount.

Next, in a step 30, which is the last in the ADTIMER process 12, the user's ID and/or IP address are obtained. [Effectively, an user's IP address is itself a form of identification.]

In a step 32 the dwell measurement process 10 allows the normal ON_CLICK code to execute but does not exit.

Instead, in a step 34, which is in the ADMSG process 14, the information which was obtained by the ADTIMER process 12 is used to compose a message. Then, in a step 36, which is the last in the ADMSG process 14, this message is sent to the sponsor that has provided the channel. And now the dwell measurement process 10 exits.

Finally, the ADTIMER process 12 and the ADMSG process 14 have been described above as discrete, for clarity in this presentation, but they can be combined into one software module. The ADTIMER process 12 or both the ADTIMER process 12 and the ADMSG process 14 can be implemented as inline code within the appropriate ON_CLICK event code, or they can be implemented as called routines.

While an embodiment has been described above, it should be understood it has been presented by way of example only, and that the breadth and scope of the invention should not be limited by the above described exemplary embodiment, but should instead be defined only in accordance with the following claims and their equivalents.

1. A process for measuring the dwell time of a user on an advertiser's clickable advertisement in a sponsor's web page, browser, or downloaded program (hereinafter a “channel”) appearing in a global communications network like the internet, the process comprising:
(a) monitoring for a click event by the user in the channel;
(b) determining whether said click event is on the advertisement;
(c) if said click event is on the advertisement:
(1) obtaining a start time; and
(2) opening a log entry that the user is accessing the advertisement; and
(d) if said click event is not on the advertisement:
(1) determining whether a said log entry already exists; and
(2) if said a said log entry does exist:
(i) obtaining a stop time; and
(ii) calculating the dwell time as a difference between said start time and said stop time.

2. The process of claim 1, further comprising:
after said (d)(2)(ii):
(iii) capping the dwell time at a preset maximum if the dwell time would otherwise exceed said preset maximum.

3. The process of claim 1, wherein:
said (c) includes getting advertiser information identifying the advertiser;
said (d)(2) includes getting user information identifying the user;
and the process further comprises:
after said (d)(2):
(3) composing a message including the dwell time, said advertiser information, and said user information; and
(4) sending said message to the sponsor.

4. The process of claim 3, wherein:
at least one of said advertiser information and said user information includes an internet protocol (IP) address of the advertiser or the user.

5. The process of claim 1, further comprising:
after said (d)(2)(ii):
(iii) transforming the dwell time into a transformed dwell time representing a charge to the advertiser.

6. The process of claim 5, wherein:
said (c) includes getting advertiser information identifying the advertiser;
said (d)(2) includes getting user information identifying the user;
and the process further comprises:
after said (d)(2):
(3) composing a message including said transformed dwell time, said advertiser information, and said user information; and
(4) sending said message to the sponsor.

7. The process of claim 6, wherein:
at least one of said advertiser information and said user information includes an internet protocol (IP) address of the advertiser or the user.

8. The process of claim 5, further comprising:
after said (d)(2)(iii):
(iv) capping said transformed dwell time at a preset maximum if said transformed dwell time would otherwise exceed said preset maximum.

9. A computerized system for measuring the dwell time of a user on an advertiser's clickable advertisement in a sponsor's web page, browser, or downloaded program (hereinafter a “channel”) appearing in a global communications network like the internet, comprising:
a logic that monitors for a click event by the user in the channel;
a logic that determines whether said click event is on the advertisement;
a logic that obtains a start time and opens a log entry that the user is accessing the advertisement, when said click event is on the advertisement;
a logic that determines whether a said log entry already exists, when said click event is not on the advertisement; and
a logic that obtains a stop time and calculates the dwell time based on a difference between said start time and said stop time, when said a said log entry does exist.

10. The system of claim 9, wherein:
said logic that obtains said start time further gets advertiser information identifying the advertiser;
said logic that obtains said stop time further gets user information identifying the user;
and the system further comprises:
a logic that composes a message including the dwell time, said advertiser information, and said user information; and
a logic that sends said message to the sponsor.

11. The system of claim 9, wherein:
at least one of said advertiser information and said user information includes an internet protocol (IP) address of the advertiser or the user.

12. The system of claim 9, wherein:
said logic that calculates the dwell time further transforms the dwell time into a transformed dwell time representing a charge to the advertiser.

13. The system of claim 12, wherein:
said logic that obtains said start time further gets advertiser information identifying the advertiser;
said logic that obtains said stop time further gets user information identifying the user;
and the system further comprises:
a logic that composes a message including said transformed dwell time, said advertiser information, and said user information; and
a logic that sends said message to the sponsor.

14. The system of claim 13, wherein:
at least one of said advertiser information and said user information includes an internet protocol (IP) address of the advertiser or the user.

15. A computer program, embodied on a computer readable storage medium, for measuring the dwell time of a user on an advertiser's clickable advertisement in a sponsor's web page, browser, or downloaded program (hereinafter a “channel”) appearing in a global communications network like the internet, the computer program comprising:
a code segment that monitors for a click event by the user in the channel;
a code segment that determines whether said click event is on the advertisement;
a code segment that obtains a start time and opens a log entry that the user is accessing the advertisement, when said click event is on the advertisement;
a code segment that determines whether a said log entry already exists, when said click event is not on the advertisement; and
a code segment that obtains a stop time and calculates the dwell time based on a difference between said start time and said stop time, when said a said log entry does exist.

16. The computer program of claim 15, wherein:
said code segment that obtains said start time further gets advertiser information identifying the advertiser;
said code segment that obtains said stop time further gets user information identifying the user;
and the computer program further comprises:
a code segment that composes a message including the dwell time, said advertiser information, and said user information; and
a code segment that sends said message to the sponsor.

17. The computer program of claim 16, wherein:
at least one of said advertiser information and said user information includes an internet protocol (IP) address of the advertiser or the user.

18. The computer program of claim 15, wherein:
said code segment that calculates the dwell time further transforms the dwell time into a transformed dwell time representing a charge to the advertiser.

19. The computer program of claim 18, wherein:
said code segment that obtains said start time further gets advertiser information identifying the advertiser;
said code segment that obtains said stop time further gets user information identifying the user;
and the computer program further comprises:
a code segment that composes a message including said transformed dwell time, said advertiser information, and said user information; and
a code segment that sends said message to the sponsor.

20. The computer program of claim 19, wherein:
at least one of said advertiser information and said user information includes an internet protocol (IP) address of the advertiser or the user.
